(19) United States
(12) Patent Application Publication
(10) Pub. No.: US 2022/0168695 A1
(43) Pub. Date: Jun. 2, 2022

(54) Venturi Tube

(71) Applicant: Huei Tarng Liou, Taipei City 114 (TW)

(72) Inventor: Huei Tarng Liou, Taipei City 114 (TW)

(21) Appl. No.: 17/105,671

(22) Filed: Nov. 27, 2020

(51) Int. Cl. B01F 5/04; B01F 3/04

(52) U.S. Cl. CPC B01F 5/0428; B01F 2005/0443; B01F 3/0446

(57) ABSTRACT

The invention is directed to a Venturi tube comprising: a cylindrical tube, wherein a first cone and a second cone are arranged. The first cone and the second cone are configured so that their bases face each other and are separated by a gap. A suction tube has an inlet and an outlet. The inlet is located outside of the cylindrical tube and the outlet is located between the first base and second base, i.e., the gap between the first base and the second base. The Venturi tube of this structure serving as a gas-liquid mixer will have higher gas solubility. The Venturi tube of this structure has a shorter length than traditional ones while processing the same amount of liquid and thus requires lower manufacturing cost.

### FIELD OF THE INVENTION

The invention relates to a Venturi tube which is different in internal structure from those generally available.

### BACKGROUND

Venturi tubes are well known in the art. A traditional Venturi tube 100, as shown in FIG. 1, has a convergent inlet (inlet conical tube) 112, a narrow throat 116, and a divergent outlet (outlet conical tube) 114 and works in accordance with Bernoulli's principle, which states that for a horizontal flow of fluid, points of higher fluid speed will have less pressure than points of slower fluid speed. When fluid passes through the convergent inlet 112, the velocity of the liquid flow increases. Therefore, according to Bernoulli's principle, as velocity increases, pressure decreases. The decreased pressure creates a suction effect. A Venturi tube can thus be used as a fluid-gas mixer. When the liquid flows through the Venturi tube 100, a suction effect will be created at the throat 116 where the reduced pressure will suck in gas to mix with liquid flowing through the throat 116.

Referring to FIG. 1 again, central axis Z is a longitudinal axis along Venturi tube 100. P_{fi} and P_{fo} are the fluid pressure at the inlet 112 and outlet 114, respectively. Pₐ is the gas pressure at the throat 116. When gas is sucked into the throat 116 from gas inlet 142, gas bubbles will form at the throat 116. Assuming the volume of a gas bubble formed at the throat 116 is Vₐ, which generally depends on the cross-sectional area of the throat 116, it may expand to a volume Vₑ as it reaches the outlet 114 of the Venturi tube 100. The volume V_{c} of the gas (bubble) at the outlet 114 will be the shown in the formula below.

$${V}_{c} = ( \frac{{P}_{a}}{{P}_{f o}} ) {V}_{a}$$

Since P_{fo} is greater than Pₐ, V_{c} is less than Vₐ. It suggests that bubbles will shrink as they move from the throat 116 to the outlet 114. However, due to the gradient of the pressure in the Venturi tube, upon leaving the throat 116, the gas bubbles will be pushed away from axis Z (the axial direction of the fluid stream), and toward the inner surface of the divergent outlet 114. Since the gas bubbles deviate from axis Z as they flow, they are less likely to dissolve in the fluid. As bubbles flow, the chance of bubble collision increases, which facilitates joining of bubbles to form even larger bubbles, as shown in FIG. 1.

There are two factors that affect the gas dissolution rate:

1. Cross-sectional area of the throat
The larger cross-sectional area of the throat creates larger gas bubble volume and results in less contact surface between the fluid and the gas, and consequently reduces dissolution rate.

2. Gradient of the pressure in the Venturi tube
Due to the gradient of the pressure in the Venturi tube 100, upon leaving the throat 116, the gas bubbles will be pushed away from the central axis Z and flow toward to the surface of the conical tube 114, where they are less likely to dissolve in liquid and instead tend to collide with other bubbles to form larger bubbles. Larger bubble size causes less contact between bubbles and the fluid. As a result, the gas dissolution rate is substantially reduced.

In addition to the lower gas dissolution rate, one major disadvantage is the size (length) of a Venturi tube, which not only limits the applications of a Venturi tube but also makes it costly to manufacture.

Accordingly, there is a need for an improved Venturi tube that enables greater gas dissolution rate. There is also a need for producing a Venturi tube of reduced size and reduced cost.

### SUMMARY OF INVENTION

The present invention provides a Venturi tube which also operates in accordance with Bernoulli's principle, but is of different structure from that of commonly available Venturi tubes.

The Venturi tube of the present invention comprises a cylindrical tube, a first cone, and a second cone. The first cone and the second cone are mounted in the cylindrical tube and are configured so that their bases face each other and are separated by a gap. The Venturi tube further comprises a suction tube, which has an inlet and an outlet. The inlet is located outside of the cylindrical tube and the outlet is located between the first base and second base, i.e., the gap between the first base and the second base.

With the first cone and the second cone are configured as above, a fluid passageway formed between the cylindrical tube and the first cone and the second cone is of a ring shape. The ring-shaped passageway will have a larger cross-sectional area than the throat of a traditional Venturi tube and thus have a higher flow rate. Consequently, the size of the Venturi tube of the present invention can be reduced if it is used to process the same fluid flow rate as a traditional Venturi tube.

In addition, as gas is sucked into the Venturi tube of the present invention, the size of the bubbles created will be smaller than those created in a traditional Venturi tube. The overall contact area between fluid and smaller gas bubbles is greater than that between fluid and larger gas bubbles. Accordingly, the Venturi tube of the present invention used as a gas-liquid mixer will have a higher gas dissolution rate than a traditional Venturi tube.

### BRIEF DESCRIPTION OF THE DRAWINGS

FIG. 1 shows a traditional Venturi tube.

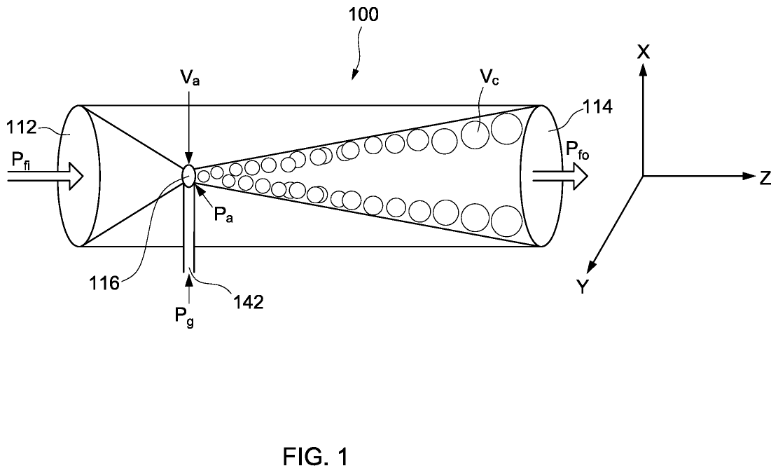

FIG. 2 shows a Venturi tube of the present invention.

### DETAILED DESCRIPTION

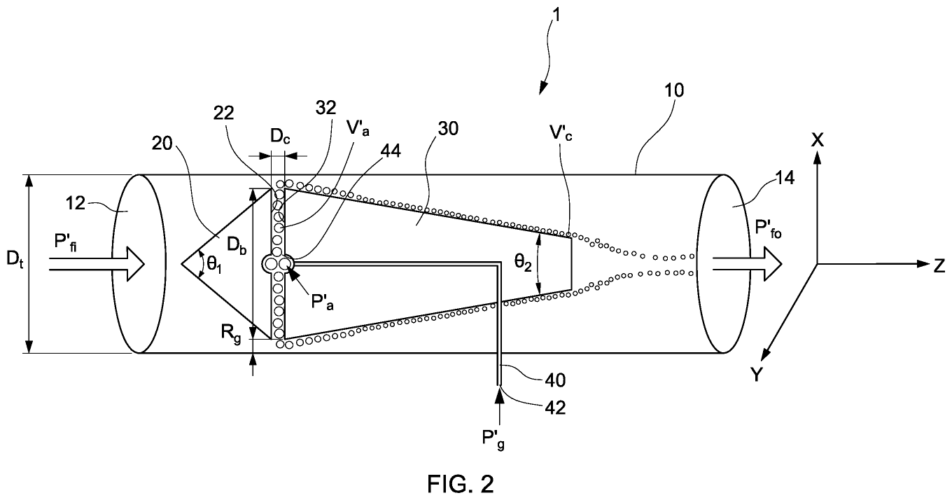

FIG. 2 shows a Venturi tube 1 of the present invention. The Venturi tube 1 comprises a cylindrical tube 10 having a fluid-in end 12 and a fluid-out end 14 with corresponding pressure P_{fi}′ and Pₕₒ′, respectively.

The Venturi tube 1 further comprises a first cone 20 and a second cone 30. The first cone 20 has a first base 22 and a first opening angle θ₁ and the second cone 30 has a second base 32 and a second opening angle θ₂. The first cone 20 is concentrically positioned in the cylindrical tube 10 with its first base 22 facing away from the fluid-in end 12. The first opening angle θ₁ is greater than the second opening angle θ₂. The second cone 30 is concentrically positioned in the cylindrical tube 10 with the second base 32 being spaced apart from the first base 22 for a distance D_{c}. In the embodiments, the distance D_{c} is 1 mm to 3 mm. The second base 32 has a base diameter D_{b} equal to that of the first base 22 and smaller than the tube diameter Dₜ. Accordingly, the gap R_{g} between the bases 22, 32 and the cylindrical tube 10 is:

$${R}_{g} = ( {D}_{t} - {D}_{b} ) / 2$$

In the embodiments, the base diameter D_{b} is 0.5 mm to 2 mm smaller than tube diameter Dₜ. The gap R_{g} then is 0.25 mm to 1 mm.

The Venturi tube 1 further comprises a suction tube 40. The suction tube 40 has an inlet 42 and an outlet 44. The inlet 42 is located outside of the cylindrical tube 10 and the outlet 44 is located between the first base 22 and second base 32. In an embodiment, the outlet 44 is located between the centers of the first base 22 and second base 32 in order to distribute the sucked gas more evenly in the fluid passing through the Venturi tube 1.

In one embodiment, the second cone 30 can be truncated. The length of a truncated cone is shorter than a cone without truncation if the opening angle and base are the same. The cylindrical tube 10 can be adapted to the truncated cone to have a reduced length. Therefore, a Venturi tube 1 with a truncated second cone 30 will be shorter in length and thus be lighter and take up less space.

Referring to FIG. 2, it can be understood that cross-section of the fluid passageway formed between the cylindrical tube 10 and the first cone 20 and second cone 30 in the Venturi tube 1 is a ring shape. Along axis Z, the cross-sectional area of the fluid passageway gradually decreases from the fluid-in end 12 and reaches the minimum at the point where the first base 22 or the second base 32 is located, and then gradually increases toward the fluid-out end 14. As a result, the fluid speed is slower at the fluid-in end 12 and at the fluid-out end 14 and is fastest at the first base 22 and the second base 32, where the fluid passageway has a minimum cross-sectional area. According to Bernoulli's principle, the pressure is a minimum at the point where the fluid speed is the fastest, that is, at the location where the cross-sectional area of the fluid passageway is a minimum.

The outlet 44 of the suction tube 40 is arranged between the centers of the first base 22 and second base 32, that is, the location where the cross-sectional area is a minimum. Gas is sucked from the outlet 44 to this location through the tube 40.

As liquid flows through the Venturi tube 1, gas is sucked out from the outlet 44 and forms bubbles. The volume and the pressure of these bubbles are assumed to be Vₐ′ and Pₐ, respectively, when the bubbles leave the outlet 44. The volume Vₐ′ is associated with the distance D_{c} between the first base 22 and the second base 32. As the bubbles continue to flow along the Venturi tube, the bubbles will shrink to volume V_{c}′ due to pressure increasing from Pₐ′ to P_{fo}′. When the bubble size is smaller, the gas solubility is higher. Due to the geometric shape of the second cone 30, liquid flowing through the Venturi tube creates a pressure gradient that pulls these small bubbles toward the surface of the second cone 30, that is, toward the central axis Z of the stream. Bubbles flowing around the central axis Z of the stream will have more chance to contact the fluid. As a result, gas dissolution rate will be higher than in the traditional Venturi tube 100, wherein bubbles flow away from the central axis Z.

In the Venturi tube of the present invention, the passageway through which the fluid flows is of a ring-shape. A ring-shaped passageway has a larger effective cross-sectional area as compared with a throat in a traditional Venturi tube, and thus has a higher flow rate. Consequently, the size of the Venturi tube can be significantly reduced.

As compared with a traditional Venturi tube, the present invention can be smaller. In addition, the Venturi tube of the present invention produces smaller bubbles and thus will have a higher gas dissolution rate.

It should be appreciated by those skilled in this art that the above embodiment is intended to be illustrative, not restrictive. Thus, additional modifications and improvements of the present invention are possible without departing from the concepts as described.

What is claimed is:

1. A Venturi tube, comprising:
a cylindrical tube having a tube diameter, a fluid-in end, and a fluid-out end;
a first cone having a first base and a first opening angle, the first cone is concentrically positioned in the cylindrical tube with its first base facing away from the fluid-in end;
a second cone having a second base and a second opening angle, the second cone being concentrically positioned in the cylindrical tube with the second base being spaced apart from the first base for a distance, the second base having a base diameter equal to that of the first base and smaller than the tube diameter; and
a suction tube having an inlet and an outlet, the inlet being located out of the cylindrical tube and the outlet being located between the first base and second base.

2. The Venturi tube according to claim 1, wherein the first opening angle is greater than the second opening angle.

3. The Venturi tube according to claim 2, wherein the second cone is truncated and the cylindrical tube is adapted to the truncated cone to shorten its length.

4. The Venturi tube according to claim 2, wherein the outlet is located between the centers of the first base and second base.

5. The Venturi tube according to claim 3, wherein the outlet is located between the centers of the first base and second base.

6. The Venturi tube according to claim 5, wherein the distance between the first base and the second base is 1 mm to 3 mm.

7. The Venturi tube according to claim 5, wherein the diameter of the first base is 0.5 mm to 2 mm less than that of the cylindrical tube.

8. The Venturi tube according to claim 6, wherein the diameter of the first base is 0.5 mm to 2 mm less than that of the cylindrical tube.
